(19) United States
(12) Patent Application Publication
(10) Pub. No.: US 2013/0127803 A1
(43) Pub. Date: May 23, 2013

(54) DEVICE FOR EXITING SCREEN SAVER MODE

(71) Applicants: GUANG-DONG YUAN, Shenzhen City (CN); CHUNG-CHI HUANG, Tu-Cheng (TW); HAI-QING ZHOU, Shenzhen City (CN)

(72) Inventors: GUANG-DONG YUAN, Shenzhen City (CN); CHUNG-CHI HUANG, Tu-Cheng (TW); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/590,436

(22) Filed: Aug. 21, 2012

(30) Foreign Application Priority Data
Nov. 23, 2011 (CN) 201110375882.6

(51) Int. Cl. G09G 5/00

(52) U.S. Cl. 345/207

(57) ABSTRACT

A device includes an infrared sensor, a signal processing unit, a first signal conversion unit, a second signal conversion unit, and an interface. The infrared sensor senses infrared rays and outputs a signal to the signal processing unit. The signal processing unit processes the signal, and outputs a processed signal to the first signal conversion unit. The first signal conversion unit transforms the processed signal into a keyboard signal, and outputs the keyboard signal to the second signal conversion unit. The second signal conversion unit transforms the keyboard signal into an interface signal according to type of the interface, and outputs the interface signal to the interface. The interface outputs the interface signal to a computer connected to the interface, to cause the computer to exit a screen saver mode.

### BACKGROUND

1. Technical Field

The present disclosure relates to devices, and more particularly to a device for exiting a screen saver mode.

2. Description of Related Art

A screen saver mode can be exited by activating a key on a keyboard or clicking a mouse of the computer. However, when the computer is tested in a hot or cold test box, a tester outside the test box wants to obtain test data of the computer, and when the computer enters a screen saver mode, the tester would have to find ways to make the computer in the test box exit the screen saver mode, which is inconvenient.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of a device in accordance with an exemplary embodiment of the present disclosure.

FIG. 2 is a block diagram of the device of FIG. 1 connected to a computer.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

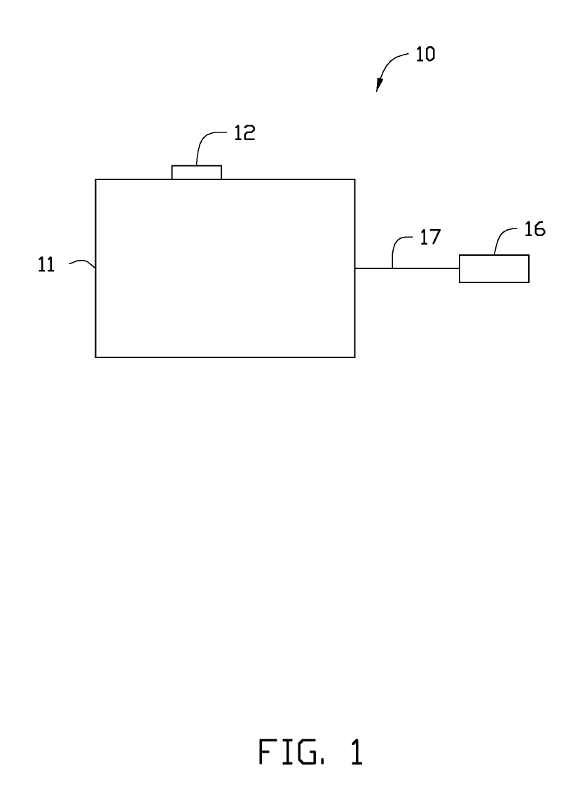

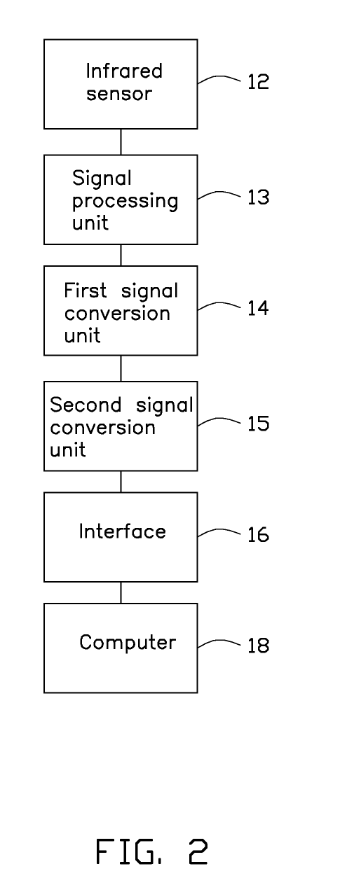

Referring to FIGS. 1 and 2, an exemplary embodiment of a device 10 includes a main body 11, an infrared sensor 12, a signal processing unit 13, a first signal conversion unit 14, a second signal conversion unit 15, an interface 16, and a cable 17. The first signal conversion unit 14 is connected to the infrared sensor 12 through the signal processing unit 13, and connected to the interface 16 through the second signal conversion unit 15.

In one embodiment, the main body 11 includes a space to receive the signal processing unit 13, the first signal conversion unit 14, and the second signal conversion unit 15. The infrared sensor 12 is positioned on an outer surface of the main body 11. The interface 16 is outside the main body 11, and connected to the main body 11 through the cable 17. It may be understood that a length of the cable 17 can be adjusted according to actual need.

The infrared sensor 12 is used to sense infrared rays emanating from a human being, and output a signal to the signal processing unit 13, according to the detection. The signal processing unit 13 is used to process the signal received from the infrared sensor 12, and output a processed signal to the first signal conversion unit 14. The first signal conversion unit 14 is used to transform the processed signal into a signal which emulates a keystroke on the keyboard (that is a keyboard signal), and outputs the keyboard signal to the second signal conversion unit 15. The second signal conversion unit 15 transforms the keyboard signal into an interface signal, and output the interface signal to the interface 16. The interface 16 outputs the interface signal to a computer 18 connected to the interface 16, to make the computer 18 exit a screen saver mode. The interface signal may be a universal serial bus (USB) signal, or a personal system 2 (PS/2) signal, the interface 16 may be an USB interface, or a PS/2 interface. When the interface 16 is a USB interface, the second signal conversion unit 15 is used to further transform the keyboard signal into a USB signal. When the interface 16 is a PS/2 interface, the second signal conversion unit 15 is used to further transform the keyboard signal into a PS/2 signal. That is, the second signal conversion unit 15 transforms the keyboard signal into an interface signal according to type of the interface 16.

In use, when a person is close to the device 10, the infrared sensor 12 senses infrared rays emanating from the person, and outputs a signal to the signal processing unit 13, according to the detection. The signal processing unit 13 processes the signal received from the infrared sensor 12, and outputs a processed signal to the first signal conversion unit 14. The first signal conversion unit 14 transforms the processed signal into a keyboard signal, and outputs the keyboard signal to the second signal conversion unit 15. The second signal conversion unit 15 transforms the keyboard signals into an interface signal according to type of the interface 16, and outputs the interface signal to the interface 16. The interface 16 outputs the interface signal to the computer 18, causing the computer to exit a screen saver mode. The end result of the above process is similar to activating a key on a keyboard of the computer, to make the computer exit a screen saver mode. Further, the interface 16 is connected to the computer through the cable 17. Therefore, the device 10 can function at a certain distance from the computer.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A device, comprising:
an infrared sensor to sensor infrared rays and output a signal according to the detection;
a signal processing unit connected to the infrared sensor to receive the signal, wherein the signal processing unit processes the signal and outputs a processed signal;
a first signal conversion unit connected to the signal processing unit to receive the processed signal, wherein the first signal conversion unit transforms the processed signal into a keyboard signal, and outputs the keyboard signal;
a second signal conversion unit connected to the first signal conversion unit to receive the keyboard signal, wherein the second signal conversion unit transforms the keyboard signal into an interface signal, and outputs the interface signal; and
an interface connected to the second signal conversion unit to receive the interface signal, wherein the interface outputs the interface signal to a computer connected to the interface, to make the computer exit a screen saver mode.

2. The device of claim 1, further comprising a main body and a cable, wherein the main body comprises a space to receive the signal processing unit, the first signal conversion unit, and the second signal conversion unit, the infrared sensor is positioned on an outer surface of the main body, the interface is outside the main body, and connected to the main body through the cable.

3. The device of claim 1, wherein the second signal conversion unit transforms the keyboard signal into the interface signal according to type of the interface.

4. The device of claim 3, wherein the second signal conversion unit transforms the keyboard signal into a universal serial bus (USB) signal is respose to the interface being a USB interface.

5. The device of claim 3, wherein the second signal conversion unit transforms the keyboard signal into a personal system 2 (PS/2) signal signal is respose to the interface being a PS/2 interface.
